(19) United States
(12) Patent Application Publication
(10) Pub. No.: US 2026/0067937 A1
(43) Pub. Date: Mar. 5, 2026

(54) CONNECTED MODE RANDOM ACCESS PROCEDURES WITH COMMON RANDOM ACCESS CONFIGURATION

(71) Applicant: QUALCOMM Incorporated, San Diego, CA (US)

(72) Inventors: Chiranjib SAHA, Lakeside, CA (US); Muhammad Sayed Khairy ABDELGHAFFAR, San Jose, CA (US); Ahmed Attia ABOTABL, San Diego, CA (US)

(21) Appl. No.: 18/825,857

(22) Filed: Sep. 5, 2024

(51) Int. Cl. H04W 74/0833; H04L 5/14; H04W 72/21

(52) U.S. Cl. CPC H04W 74/0833; H04L 5/14; H04W 72/21

(57) ABSTRACT

Methods, systems, and devices for wireless communications are described. Techniques described herein provide for connected mode random access procedures with common random access configuration. In some examples, a user equipment may receive receiving a common random access configuration. The common random access configuration may be associated with one or more time domain duplex (TDD) uplink resources for random access and one or more subband full duplex (SBFD) uplink resources for random access. The UE may participate in a random access procedure based on occurrence of a trigger event during a connected mode of the UE. The random access procedure may be performed on a random access resource associated with the common random access configuration. The random access resource may be determined from the TDD uplink resources, from the SBFD uplink resources, or from both the TDD uplink resources and the SBFD uplink resources.

### INTRODUCTION

The following generally relates to wireless communications, and more specifically to performing random access procedures.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving a common random access configuration, where the common random access configuration is associated with one or more time domain duplex (TDD) uplink resources for random access and one or more subband full duplex (SBFD) uplink resources for random access and participating in a random access procedure based on occurrence of a trigger event during a radio resource control (RRC) connected mode of the UE, where the random access procedure is performed on a random access resource associated with the common random access configuration, the random access resource determined from the one or more time division duplexing (TDD) uplink resources, from the one or more SBFD uplink resources, or from both the one or more TDD uplink resources and the one or more SBFD uplink resources based on the common random access configuration and based on an absence, at the UE, of a dedicated random access configuration that indicates the trigger event.

An apparatus for wireless communication at a UE is described. The apparatus may include one or more memories, and one or more processors coupled with the one or more memories and configured to cause the UE to receive a common random access configuration, where the common random access configuration is associated with one or more TDD uplink resources for random access and one or more SBFD uplink resources for random access and participate in a random access procedure based on occurrence of a trigger event during an RRC connected mode of the UE, where the random access procedure is performed on a random access resource associated with the common random access configuration, the random access resource determined from the one or more TDD uplink resources, from the one or more SBFD uplink resources, or from both the one or more TDD uplink resources and the one or more SBFD uplink resources based on the common random access configuration and based on an absence, at the UE, of a dedicated random access configuration that indicates the trigger event.

Another apparatus for wireless communication at a UE is described. The apparatus may include means for receiving a common random access configuration, where the common random access configuration is associated with one or more TDD uplink resources for random access and one or more SBFD uplink resources for random access and means for participating in a random access procedure based on occurrence of a trigger event during an RRC connected mode of the UE, where the random access procedure is performed on a random access resource associated with the common random access configuration, the random access resource determined from the one or more TDD uplink resources, from the one or more SBFD uplink resources, or from both the one or more TDD uplink resources and the one or more SBFD uplink resources based on the common random access configuration and based on an absence, at the UE, of a dedicated random access configuration that indicates the trigger event.

A non-transitory computer-readable medium storing code for wireless communication at a UE is described. The code may include instructions executable by one or more processors to cause the UE to receive a common random access configuration, where the common random access configuration is associated with one or more TDD uplink resources for random access and one or more SBFD uplink resources for random access and participate in a random access procedure based on occurrence of a trigger event during an RRC connected mode of the UE, where the random access procedure is performed on a random access resource associated with the common random access configuration, the random access resource determined from the one or more TDD uplink resources, from the one or more SBFD uplink resources, or from both the one or more TDD uplink resources and the one or more SBFD uplink resources based on the common random access configuration and based on an absence, at the UE, of a dedicated random access configuration that indicates the trigger event.

Some examples of the method, user equipment (UEs), and non-transitory computer-readable medium described herein may further include operations, features, means, or instructions for receiving an indication prior to determination of the random access resource, the determination of the random access resource by the UE based on the indication that indicates the random access resource may be selected from the one or more TDD uplink resources.

Some examples of the method, user equipment (UEs), and non-transitory computer-readable medium described herein may further include operations, features, means, or instructions for receiving an indication prior to determination of the random access resource, the determination of the random access resource by the UE based on the indication that indicates the random access resource may be selected from the one or more SBFD uplink resources.

Some examples of the method, user equipment (UEs), and non-transitory computer-readable medium described herein may further include operations, features, means, or instructions for receiving an indication prior to determination of the random access resource, the determination of the random access resource by the UE based on the indication that indicates the random access resource may be selected from both the one or more TDD uplink resources and the one or more SBFD uplink resources.

Some examples of the method, user equipment (UEs), and non-transitory computer-readable medium described herein may further include operations, features, means, or instructions for selecting the random access resource from only the one or more SBFD uplink resources.

Some examples of the method, user equipment (UEs), and non-transitory computer-readable medium described herein may further include operations, features, means, or instructions for receiving, from a network entity, a prioritization signal, where the prioritization signal prioritizes the one or more TDD uplink resources over the one or more SBFD uplink resources or the one or more SBFD uplink resources over the one or more TDD uplink resources and selecting the random access resource from only the one or more TDD uplink resources or from only the one or more SBFD uplink resources based on the prioritization signal.

Some examples of the method, user equipment (UEs), and non-transitory computer-readable medium described herein may further include operations, features, means, or instructions for receiving a reference signal, measuring a reference signal received power associated with the reference signal, and selecting the random access resource from the one or more SBFD uplink resources based on satisfaction of a threshold by the reference signal received power.

Some examples of the method, user equipment (UEs), and non-transitory computer-readable medium described herein may further include operations, features, means, or instructions for selecting the random access resource from the one or more SBFD uplink resources based on satisfaction of a threshold by a transmit power associated with the random access procedure.

Some examples of the method, user equipment (UEs), and non-transitory computer-readable medium described herein may further include operations, features, means, or instructions for receiving a radio resource control parameter prior to determination of the random access resource, the determination of the random access resource by the UE based on the radio resource control parameter that indicates the random access resource may be selected from the one or more TDD uplink resources, the one or more SBFD uplink resources, or both the one or more TDD uplink resources and the one or more SBFD uplink resources.

Some examples of the method, user equipment (UEs), and non-transitory computer-readable medium described herein may further include operations, features, means, or instructions for selecting the random access resource from only the one or more TDD uplink resources based on an absence of a radio resource control parameter that indicates that the random access resource may be selected from the one or more TDD uplink resources, the one or more SBFD uplink resources, or both the one or more TDD uplink resources and the one or more SBFD uplink resources.

A method for wireless communication by a network entity is described. The method may include outputting, to a UE, a common random access configuration, where the common random access configuration is associated with one or more TDD uplink resources for random access and one or more SBFD uplink resources for random access and outputting, to the UE, an indication associated with selection of a random access resource for participation in a random access procedure, where the indication indicates the random access resource is to be selected from the one or more TDD uplink resources, the one or more SBFD uplink resources, or both the one or more TDD uplink resources and the one or more SBFD uplink resources based on the common random access configuration and based on an absence of a dedicated random access configuration that indicates a trigger event for the random access procedure.

An apparatus for wireless communication at a network entity is described. The apparatus may include one or more memories, and one or more processors coupled with the one or more memories and configured to cause the network entity to output, to a UE, a common random access configuration, where the common random access configuration is associated with one or more TDD uplink resources for random access and one or more SBFD uplink resources for random access and output, to the UE, an indication associated with selection of a random access resource for participation in a random access procedure, where the indication indicates the random access resource is to be selected from the one or more TDD uplink resources, the one or more SBFD uplink resources, or both the one or more TDD uplink resources and the one or more SBFD uplink resources based on the common random access configuration and based on an absence of a dedicated random access configuration that indicates a trigger event for the random access procedure.

Another apparatus for wireless communication at a network entity is described. The apparatus may include means for outputting, to a UE, a common random access configuration, where the common random access configuration is associated with one or more TDD uplink resources for random access and one or more SBFD uplink resources for random access and means for outputting, to the UE, an indication associated with selection of a random access resource for participation in a random access procedure, where the indication indicates the random access resource is to be selected from the one or more TDD uplink resources, the one or more SBFD uplink resources, or both the one or more TDD uplink resources and the one or more SBFD uplink resources based on the common random access configuration and based on an absence of a dedicated random access configuration that indicates a trigger event for the random access procedure.

A non-transitory computer-readable medium storing code for wireless communication at a network entity is described. The code may include instructions executable by one or more processors cause the network entity to output, to a UE, a common random access configuration, where the common random access configuration is associated with one or more TDD uplink resources for random access and one or more SBFD uplink resources for random access and output, to the UE, an indication associated with selection of a random access resource for participation in a random access procedure, where the indication indicates the random access resource is to be selected from the one or more TDD uplink resources, the one or more SBFD uplink resources, or both the one or more TDD uplink resources and the one or more SBFD uplink resources based on the common random access configuration and based on an absence of a dedicated random access configuration that indicates a trigger event for the random access procedure.

In some examples of the method, network entities, and non-transitory computer-readable medium described herein, the indication indicates the random access resource may be selected from the one or more TDD uplink resources.

In some examples of the method, network entities, and non-transitory computer-readable medium described herein, the indication indicates the random access resource may be selected from the one or more SBFD uplink resources.

In some examples of the method, network entities, and non-transitory computer-readable medium described herein, the indication indicates the random access resource may be selected from both the one or more TDD uplink resources and the one or more SBFD uplink resources.

Some examples of the method, network entities, and non-transitory computer-readable medium described herein may further include operations, features, means, or instructions for outputting, to the UE, a prioritization signal, where the prioritization signal prioritizes the one or more TDD uplink resources over the one or more SBFD uplink resources or the one or more SBFD uplink resources over the one or more TDD uplink resources.

In some examples of the method, network entities, and non-transitory computer-readable medium described herein, the indication may be a radio resource control parameter included in a radio resource control signal.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports connected mode random access procedures with common random access configuration in accordance with one or more aspects of the present disclosure.

FIG. 2 shows an example of a network architecture that supports connected mode random access procedures with common random access configuration in accordance with one or more aspects of the present disclosure.

FIG. 3 shows an example of a wireless communications system that supports connected mode random access procedures with common random access configuration in accordance with one or more aspects of the present disclosure.

FIG. 4 shows an example of a process flow that supports connected mode random access procedures with common random access configuration in accordance with one or more aspects of the present disclosure.

FIGS. 5 and 6 show block diagrams of devices that support connected mode random access procedures with common random access configuration in accordance with one or more aspects of the present disclosure.

FIG. 7 shows a block diagram of a communications manager that supports connected mode random access procedures with common random access configuration in accordance with one or more aspects of the present disclosure.

FIG. 8 shows a diagram of a system including a device that supports connected mode random access procedures with common random access configuration in accordance with one or more aspects of the present disclosure.

FIGS. 9 and 10 show block diagrams of devices that support connected mode random access procedures with common random access configuration in accordance with one or more aspects of the present disclosure.

FIG. 11 shows a block diagram of a communications manager that supports connected mode random access procedures with common random access configuration in accordance with one or more aspects of the present disclosure.

FIG. 12 shows a diagram of a system including a device that supports connected mode random access procedures with common random access configuration in accordance with one or more aspects of the present disclosure.

FIGS. 13 through 15 show flowcharts illustrating methods that support connected mode random access procedures with common random access configuration in accordance with one or more aspects of the present disclosure.

### DETAILED DESCRIPTION

In some examples of wireless communications, a user equipment (UE) may perform a random access procedure, where the UE determines to establish an initial connection with a network entity. In some cases, the UE may be triggered to perform the random access procedure (e.g., RACH procedure) in a radio resource control (RRC) connected mode. For random access procedure, the network entity may configure the UE with one or more random access configurations that correspond to respective sets of resources to use to perform a random access procedure. In some examples, the random access configurations may be associated with time domain duplex (TDD) uplink resources or subband full duplex (SBFD) resources. In some cases, the UE may be configured with a dedicated random access configuration to indicate a random access triggering event. A random access trigger event may be an occurrence that initiates the random access procedure between the UE and the network entity. When the UE is not configured with a dedicated random access configuration to indicate a random access trigger event in the RRC connected mode, the UE may derive random access resources from a common random access configuration that includes TDD uplink resources and SBFD resources. Currently, there is no procedure for the UE, while operating in the RRC connected mode, to follow when deriving random access resources from the common random access configuration. For example, there is no procedure for the UE to select random access resources from the configured TDD resources, SBFD resources, or both the TDD resources and the SBFD resources that results in ambiguity in which random access resource that the UE may select. Due to this ambiguity, the network entity may monitor each resource of the common random access configuration resulting in an inefficient use of resources.

According to the techniques described herein, if the UE is not configured with a dedicated random access configuration to indicate a random access trigger event in the RRC connected mode, the UE may derive the random access resources from the common random access configuration. The dedicated random access configuration to indicate a RACH trigger event is a set of resources for use by the UE when performing the random access procedure for an associated trigger event. In some examples, the UE may be indicated to determine the random access resource from the TDD uplink resources, the SBFD resources, or both the TDD uplink resources and the SBFD resources of the common random access configuration. The TDD uplink resource for random access may be a time and frequency resource for use by the UE when performing the random access procedure. The SBFD resource for random access may be a time and frequency resource within a subband of the SBFD resource for use by the UE when performing the random access procedure.

In some cases, the UE may receive, from the network entity, a common random access configuration, and the common random access configuration may be associated with TDD uplink resources for random access and SBFD uplink resources for random access. The UE may participate in a random access procedure based on occurrence of a trigger event during a connected mode of the UE. The random access procedure may be performed on a random access resource from the common random access configuration, and the random access resource may be determined from the TDD uplink resources, from the SBFD uplink resources, or from both the TDD uplink resources and the SBFD uplink resources based on the common random access configuration and based on an absence, at the UE, of a dedicated random access configuration that indicates the trigger event. In some cases, the UE may receive an indication to select the random access resource from the TDD uplink resources. In some cases, the UE may receive an indication to select the random access resource from the SBFD resources. In some cases, the UE may receive an indication to select the random access resource from both the TDD uplink resources and the SBFD resources.

By implementing techniques to derive the random access resources from the common random access configuration, the UE may improve random access procedure performance by utilizing both TDD uplink resources and SBFD resources. In some cases, the UE may perform the random access procedure more quickly utilizing both TDD uplink resources and SBFD resources. In some cases, the UE may increase the likelihood of successful completion of the random access procedure by utilizing both TDD uplink resources and SBFD resources. In some cases, the UE and the network entity may improve the random access procedure by efficiently utilizing the communication resources.

Aspects of the disclosure are initially described in the context of wireless communications systems. Aspects of the disclosure are further illustrated by and described with reference to process flows, apparatus diagrams, system diagrams, and flowcharts that relate to connected mode random access procedures with common random access configuration.

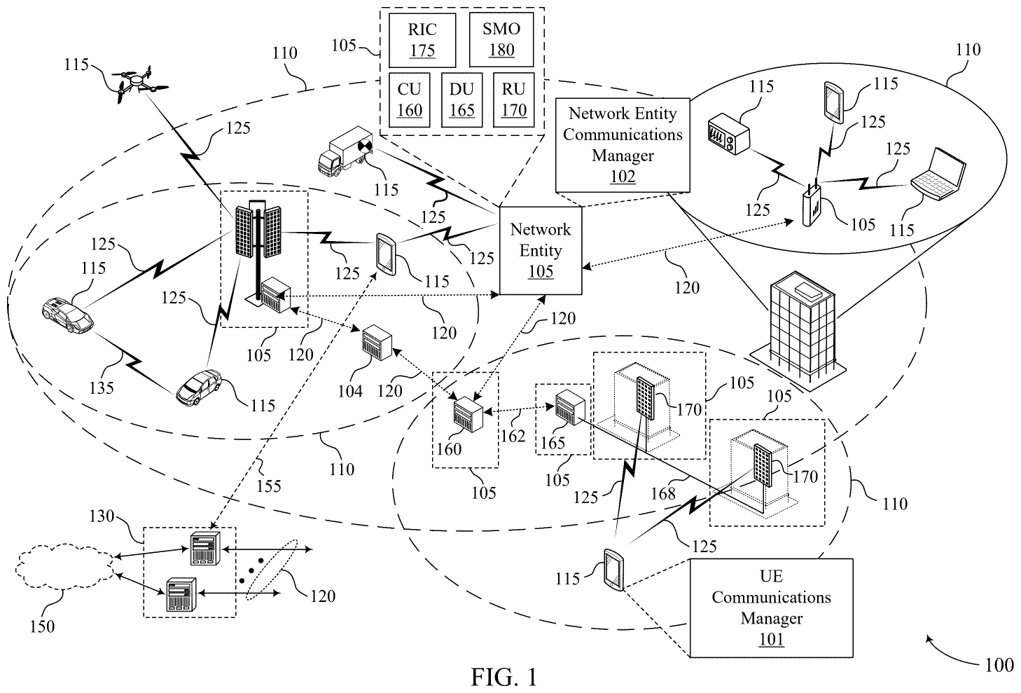

FIG. 1 shows an example of a wireless communications system 100 that supports connected mode random access procedures with common random access configuration in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein. The network entities 105 may include a network entity communications manager 102, which may be configured to support communications in the wireless communications system 100. Similarly, the UEs 115 may include a UE communications manager 101, which may be configured to support communications in the wireless communications system 100.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUS 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

Techniques described herein, in addition to or as an alternative to be carried out between UEs 115 and network entities 105, may be implemented via additional or alternative wireless devices, including IAB nodes 104, DUs 165, CUs 160, RUs 170, and the like. For example, in some implementations, aspects described herein may be implemented in the context of a disaggregated RAN architecture (e.g., open RAN architecture). In a disaggregated architecture, the RAN may be split into three areas of functionality corresponding to the CU 160, the DU 165, and the RU 170. The split of functionality between the CU 160, DU 165, and RU 170 is flexible and as such gives rise to numerous permutations of different functionalities depending upon which functions (e.g., MAC functions, baseband functions, radio frequency functions, and any combinations thereof) are performed at the CU 160, DU 165, and RU 170. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communications system 100), infrastructure and spectral resources for NR access may additionally support wireless backhaul link capabilities in supplement to wireline backhaul connections, providing an IAB network architecture. One or more network entities 105 may include CUs 160, DUs 165, and RUs 170 and may be referred to as donor network entities 105 or IAB donors. One or more DUs 165 (e.g., and/or RUs 170) associated with a donor network entity 105 may be partially controlled by CUs 160 associated with the donor network entity 105. The one or more donor network entities 105 (e.g., IAB donors) may be in communication with one or more additional network entities 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of network entities 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host L3 (e.g., RRC, SDAP, PDCP, etc.) functionality and signaling. The at least one DU 165 and/or RU 170 may host lower layer, such as L1 and L2 (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a network entity 105 may additionally, or alternatively, be performed by components of the disaggregated RAN architecture (e.g., IAB nodes, DUs, CUs, etc.).

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

The electromagnetic spectrum is often subdivided, based on frequency/wavelength, into various classes, bands, channels, etc. In 5G NR two initial operating bands have been identified as frequency range designations FRI (410 MHz-7.125 GHz) and FR2 (24.25 GHZ-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHZ” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nr) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrow band IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below: 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples of wireless communications, a UE 115 may perform a random access procedure, where the UE 115 determines to establish an initial connection with a network entity 105. In some cases, the UE 115 may be triggered to perform the random access procedure (e.g., RACH procedure) in a RRC connected mode. For random access procedure, the network entity 105 may configure the UE 115 with one or more random access configurations that correspond to respective sets of resources to use to perform a random access procedure. In some examples, the random access configurations may be associated with TDD uplink resources or SBFD resources. In some cases, the UE 115 may be configured with a dedicated random access configuration to indicate a random access triggering event. A random access trigger event may be an occurrence that initiates the random access procedure between the UE 115 and the network entity 105. When the UE 115 is not configured with a dedicated random access configuration to indicate a random access trigger event, the UE 115 may derive random access resources from a common random access configuration that includes TDD uplink resources and SBFD resources. Currently, there is no procedure for the UE 115, while operating in the RRC connected mode, to follow when deriving random access resources from the common random access configuration.

According to the techniques described herein, if the UE 115 is not configured with a dedicated random access configuration to indicate a random access trigger event, the UE 115 may derive the random access resources from the common random access configuration. The dedicated random access configuration to indicate a random access trigger event is a set of resources for use by the UE 115 when performing the random access procedure for an associated trigger event. In some examples, the UE 115 may be indicated to determine the random access resource from the TDD uplink resources, the SBFD resources, or both the TDD uplink resources and the SBFD resources of the common random access configuration. The TDD uplink resource for random access may be a time and frequency resource for use by the UE 115 when performing the random access procedure. The SBFD resource for random access may be a time and frequency resource within a subband of the SBFD resource for use by the UE 115 when performing the random access procedure.

In some cases, the UE 115 may receive, from the network entity 105, a common random access configuration, and the common random access configuration may be associated with TDD uplink resources for random access and SBFD uplink resources for random access. The UE 115 may participate in a random access procedure based on occurrence of a trigger event during a connected mode of the UE 115. The random access procedure may performed on a random access resource from the common random access configuration, and the random access resource may be determined from the TDD uplink resources, from the SBFD uplink resources, or from both the TDD uplink resources and the SBFD uplink resources based on the common random access configuration and based on an absence, at the UE 115, of a dedicated random access configuration that indicates the trigger event. In some cases, the UE 115 may receive an indication to select the random access resource from the TDD uplink resources. In some cases, the UE 115 may receive an indication to select the random access resource from the SBFD resources. In some cases, the UE 115 may receive an indication to select the random access resource from both the TDD uplink resources and the SBFD resources.

By implementing techniques to derive the random access resources from the common random access configuration, the UE 115 may improve random access procedure performance by utilizing both TDD uplink resources and SBFD resources. In some cases, the UE 115 may perform the random access procedure more quickly utilizing both TDD uplink resources and SBFD resources. In some cases, the UE 115 may increase the likelihood of successful completion of the random access procedure by utilizing both TDD uplink resources and SBFD resources.

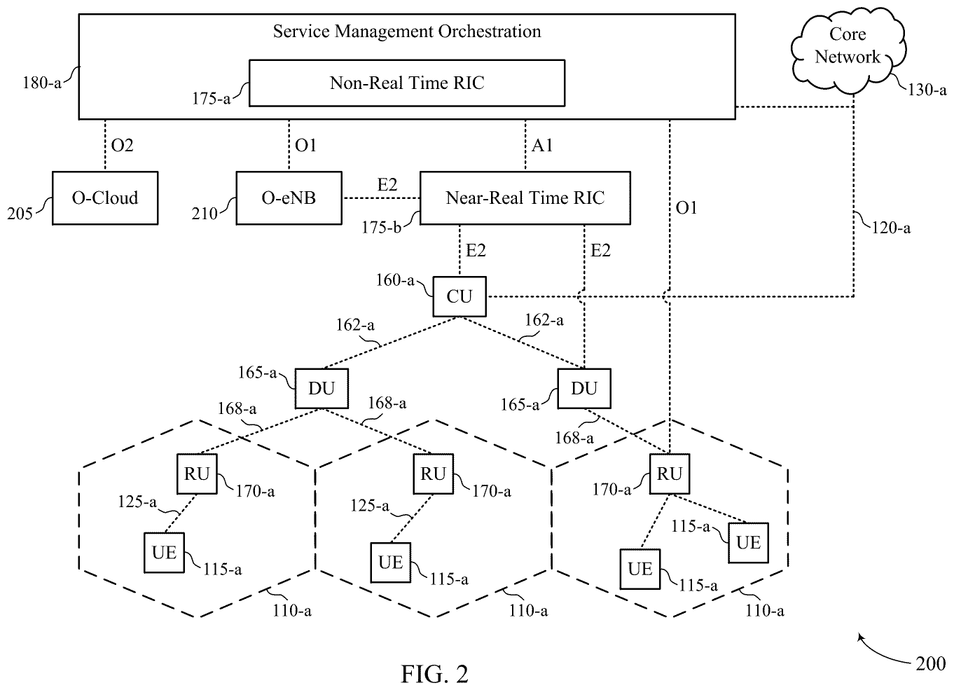

FIG. 2 shows an example of a network architecture 200 (e.g., a disaggregated base station architecture, a disaggregated RAN architecture) that supports connected mode random access procedures with common random access configuration in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an AI interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., AI policies).

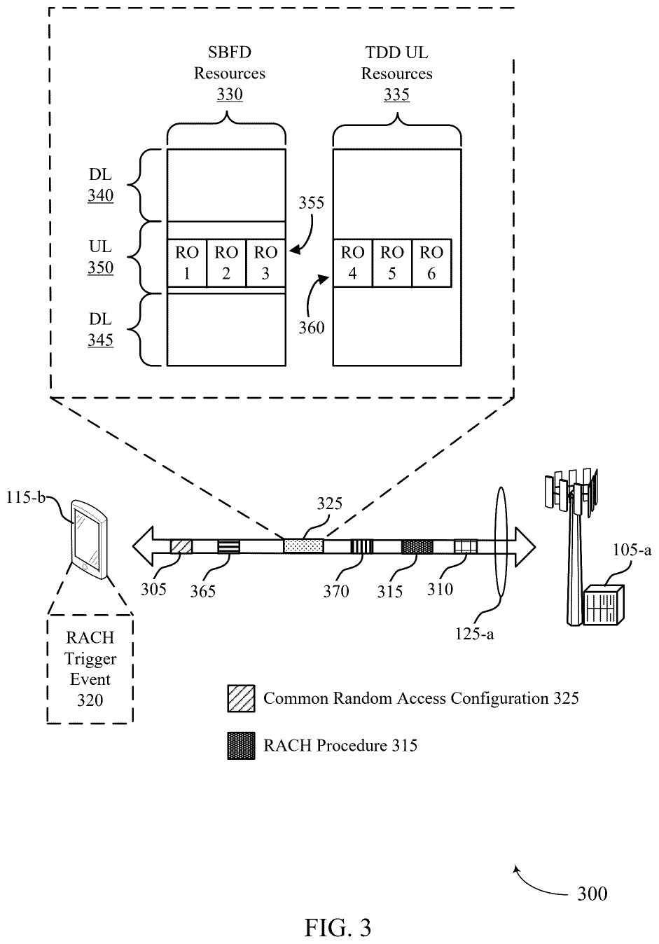

FIG. 3 shows an example of a wireless communications system 300 that supports connected mode random access procedures with common random access configuration in accordance with one or more aspects of the present disclosure. The wireless communications system 300 may implement or may be implemented by aspects of the wireless communications system 100 or the network architecture 200. For example, the wireless communications system 300 may include a UE 115-b, which may be an example of a UE 115 as described herein. The wireless communications system 300 may include a network entity 105-a, which may be an example of a network entity 105 as described herein.

In some examples, the UE 115-b may communicate with the network entity 105-a using a communication link 125-a. The communication link 125-a may be an example of a 6th generation (6G), a NR or LTE link between the UE 115-b and the network entity. The communication link 125-a may include a bi-directional link that enable both uplink and downlink communications. For example, the UE 115-b may transmit uplink signals 305 (e.g., uplink transmissions), such as uplink control signals or uplink data signals, to the network entity 105-a using the communication link 125-a and the network entity 105-a may transmit downlink signals 310 (e.g., downlink transmissions), such as downlink control signals or downlink data signals, to the UE 115-b using the communication link 125-a.

As illustrated in FIG. 3, the UE 115-b and network entity 105-a may operate in accordance with a random access (RACH) procedure 315. In some aspects, a RACH procedure 315 is a procedure in which the UE 115-b may establish an initial connection with a network (e.g., via the network entity 105-a). The UE 115-b may determine to perform the RACH procedure 315 based on the occurrence of a RACH trigger event 320. For instance, the UE 115-b may perform the RACH procedure 315 as an initial access from a RRC idle state, to transition from the RRC inactive state to the RRC connected state, and for RRC connection re-establishment. In some cases, the UE 115-b may determine to perform the RACH procedure when operating in a connected stated (e.g., RRC_CONNECTED mode) based on the occurrence of the RACH trigger event 320. For example, the RACH trigger event may be downlink or uplink data arrival, during RRC_CONNECTED mode, when uplink synchronization status is non-synchronized, uplink data arrival, during RRC_CONNECTED mode, when no physical uplink control channel (PUCCH) resources for a scheduling request are available, and uplink data arrival without physical uplink shared channel (PUSCH) resource allocation. In some cases, the trigger event may be to perform a handover procedure from a first cell of the network to a second cell of the network, a scheduling request failure, a synchronous reconfiguration, an RRC connection resume procedure from the RRC inactive state, to establish time alignment for a primary timing advance group (TAG) or a secondary TAG, to establish time alignment during secondary cell (SCell) addition, a request for other system information (SI), a beam failure recover, a consistent uplink listen-before-talk (LBT) failure on a special cell (SpCell), a positioning purpose during the RRC_CONNECTED mode requiring a RACH (e.g., when timing advance is used for UE positioning), an early uplink synchronization with a long-term management (LTM) candidate cell, and a RACH based LTM cell switch.

In some aspects, the RACH procedure 315 may be a contention free random access (CFRA) procedure or a contention-based random access (CBRA) procedure. In some aspects, CFRA may be a RACH method where the UE 115-b is assigned resources or time slots to transmit initial connection requests to the network entity 105-a (e.g., without contention). For example, the network entity 105-a may allocate to the UE 115-b a dedicated opportunity to access the network without having to compete with other devices (e.g., other UEs 115) for access. In the case of CFRA, the network entity 105-a may allocate a dedicated RACH preamble to the UE 115-b (e.g., via RRC signaling by ra-PreambleIndex. or via Layer I signaling within a DCI on a PDCCH). The UE 115-b and network entity 105-a may use CFRA in cases where a quantity of devices is relatively low or in cases where deterministic access may reduce delays and collisions of wireless communications.

In some aspects, CBRA may be a method where multiple UEs 115 contend for access to the network resources. In CBRA, multiple UEs 115 may attempt to access the network concurrently, and collisions may occur if multiple UEs 115 choose the same resources or time slots. To mitigate collisions, the wireless communications system 300 may implement protocols such as random backoff or contention resolution mechanisms. For instance, if multiple UEs 115 select a same preamble, the multiple UEs 115 may decode a same content from a random access response (RAR), and each transmit a respective message (e.g., MSG3) using the same set of resource blocks and symbols. As such, the network entity 105-a may decode one of the respective messages from the multiple UEs and may perform contention resolution. If the respective messages include a common control channel (CCCH) message, the network entity 105-a may perform contention resolution based on including a medium access control-control element (MAC-CE) message in a response message (e.g., MSG4) to the selected UE 115-b. If the respective messages include a dedicated control channel (DCCH) message or a dedicated traffic channel (DTCH) message, the network entity 105-a may perform contention resolution based on addressing the selected UE 115-b (e.g., via an associated cell radio network temporary identifier (C-RNTI) in a PDCCH transmission. As such, the selected UE 115-b may complete the CBRA procedure while the remaining UEs 115 may continue the CBRA procedure by selecting a different preamble. The UE 115-b and network entity 105-a may use CBRA to reduce overhead associated with allocating dedicated resources for each UE.

In some examples, the network entity 105-a may perform subband non-overlapping (SBFD) operations. For SBFD operation at the network entity 105-a with a TDD carrier, the network entity 105-a may specify a semi-static indication of time location of SBFD subbands to the UE 115-b (or multiple UEs) in the RRC_CONNECTED mode. In some cases, the network may indicate the time location of SBFD subbands in system information blocks (SIBs). The network entity 105-a may specify a semi-static indication of frequency domain location of SBFD subbands to the UE 115-b (or multiple UEs) in the RRC_CONNECTED mode. In some cases, the network entity 105-a may indicate the frequency domain location of SBFD subbands in system information blocks (SIBs). In some examples, the network entity 105-a may specify SBFD operation to support random access in SBFD symbols by the UEs in the RRC_CONNECTED mode and specify SBFD operation to the UE in RRC_IDLE or RRC_INACTIVE mode for random access.

SBFD resources may allow for the UE 115-b to perform concurrent transmission and reception of wireless communications on different frequency subbands that span a same spectrum bandwidth. In some cases, the network entity 105-a may configure SBFD resources for both four-step RACH procedures and two-step RACH procedures. Additionally, or alternatively, the network entity 105-a may configure SBFD resources for both CBRA procedures and CFRA procedures. In some cases, the network may configure the RACH resources for SBFD-aware UEs (e.g., UEs that may operate with SBFD resources) or legacy UEs (e.g., UEs that may not operate with SBFD resources). Additionally, or alternatively, the network entity 105-a may have additional cell-specific RACH configuration dedicated for SBFD-aware UEs or the network entity may have a common RACH configuration for both SBFD-aware UEs and legacy UEs that are not SBFD-aware. Additionally, or alternatively, the network entity 105-a may enable an SBFD dedicate RACH configuration for a subset of use cases (e.g., RACH trigger events of beam failure recovery, handover, scheduling request failure, of physical downlink control channel (PDCCH) order) or the network entity 105-a may not restrict the SBFD RACH configuration to configured trigger events. Additionally, or alternatively, the network entity may configure SBFD-aware UEs with SBFD dedicated configuration for two step RACH procedure (e.g., msgA paging occasion (msgA-PO) and msgA random access occasion (msg-RO)) preambles and msgA PUSCH configuration or the network entity 105—may configure SBFD-aware UEs and legacy UEs with a single RACH or PUSCH configuration.

In some examples, the UE 115-b may perform the RACH procedure 315 in accordance with a common random access configuration (common RACH configuration). In some cases, the network entity 105-a may configure one common RACH configuration using a single physical random access channel (PRACH) configuration index or may configure two common RACH configurations with separate PRACH configuration indices. In some cases, the UE 115-b may receive, from the network entity 105-a, a common RACH configuration 325. In some examples, the common RACH configuration 325 may indicate SBFD resources 330 for random access and TDD uplink resources 335 for random access. The SBFD resources 330 include downlink subbands (e.g., downlink subband 340) and downlink subband 345) and an uplink subband 350. Within the uplink subband 350 of the SBFD resources, the network entity 105-a may configure RACH occasions (e.g., ROs 355). Within the TDD uplink resources 335, the network entity 105-a may configure RACH occasions (e.g., ROs 360). In some cases, the UE 115-b may be a SBFD-aware UE, and the UE 115-b may perform the RACH procedure on a RACH resource (e.g., ROs 355 and ROs 360) of the common RACH configuration 325. The RACH resource may be determined from the TDD uplink resources 335, from the SBFD resources 330, or from both the TDD uplink resources 335 and the SBFD resources 330 of the common RACH configuration 325. In some cases, the UE 115-b may not be configured with a dedicated RACH configuration that indicates the trigger event associated with the RACH procedure. In some cases, the UE 115-b may not be a SBFD-aware UE (e.g., legacy UE), and the UE 115-b may perform the RACH procedure on a RACH resource (e.g., ROs 360) determined from the TDD uplink resources 335 and may not use the RACH resource (e.g., ROs 355) determined from the SBFD resources 330 of the common RACH configuration 325.

In some cases, the UE 115-b may receive, from the network entity 105-a, the common RACH configuration 325 (e.g., RACH-ConfigCommon). The common RACH configuration 325 may indicate SBFD resources 330 for random access and TDD uplink resources 335 for random access. The common RACH configuration allows the UE 115-b (e.g., SBFD-aware UE) to transmit PRACH in SBFD random access occasions (e.g., ROs 355) or TDD random access occasions (e.g., ROs 360). Currently, there is no procedure for the UE 115-b to follow when deriving RACH resources from the common RACH configuration 325 for a RACH triggering event while the UE is operating in the RRC connected mode.

In some examples, for the SBFD-aware UE (e.g., UE 115-b) that is not configured with a UE-dedicated PRACH configuration to indicate a RACH triggering event, the UE 115-b may derive or determine the RACH resources from the common RACH configuration 325. The UE 115-b may use a RACH resource determined from the TDD uplink resources 335, from the SBFD resources 330, or from both the TDD uplink resources 335 and the SBFD resources 330.

In some cases, the UE 115-b may receive, from the network entity 105-a, an indication 365 indicating how to determine the valid random access occasions (ROs) as the ROs 360 of the TTD uplink resources 335, as the ROs 355 of the SBFD resources 330, or as the ROs of both the ROs 360 of the TTD uplink resources 335 and ROs 355 of the SBFD resources 330. For each UE dedicated PRACH configuration, if the PRACH configuration does not contain a PRACH-configuration generic, the UE 115-b may use a cell-specific PRACH-configuration generic indicated in SIB-1.

In some examples, the UE 115-b may receive an RRC parameter 370 to interpret the PRACH configuration index. For example, the RRC parameter 370 may indicate that the RACH resource is selected from the TDD uplink resources 335, the SBFD resources 330, or both the TDD uplink resources 335 and the SBFD resources 330. In some cases, the UE 115-b may select the RACH resource from only the TDD uplink resources 335 based on an absence of the RRC parameter 370 that indicates that the RACH resource is selected from the TDD uplink resources 335, the SBFD resources 330, or both the TDD uplink resources 335 and the SBFD resources 330.

In some examples, when the indication 365 or the RRC parameter 370 indicates the RACH resource is selected from the both the TDD uplink resources 335 and the SBFD resources 330, the UE 115-b may select the RACH resource from only the SBFD resources 330.

In some examples, the UE 115-b may receive, from the network entity 105-a, a prioritization signal, and the prioritization signal prioritizes the TDD uplink resources 335 over the SBFD resources 330 or prioritizes the SBFD resources 330 over the TDD uplink resources 335. In some cases, when the indication 365 or the RRC parameter 370 indicates the RACH resource is selected from the both the TDD uplink resources 335 and the SBFD resources 330, the UE 115-b may select the RACH resource from only the TDD uplink resources 335 or from only the SBFD resources 330 based on the prioritization signal.

In some examples, the UE 115-b may receive a reference signal and may measure a reference signal received power (RSRP) associated with the received reference signal. In some cases, when the indication 365 or the RRC parameter 370 indicates the RACH resource is selected from the both the TDD uplink resources 335 and the SBFD resources 330, the UE 115-b may select the RACH resource from the SBFD resources 330 based on satisfaction of a threshold by the RSRP.

In some cases, when the indication 365 or the RRC parameter 370 indicates the RACH resource is selected from the both the TDD uplink resources 335 and the SBFD resources 330, the UE 115-b may select the RACH resource from the SBFD resources 330 based on satisfaction of a threshold by a transmit power associated with the RACH procedure.

In some cases, the UE 115-b may receive, from the network entity 105-a, the common RACH configuration 325 (e.g., RACH-ConfigCommon). For the RACH-ConfigCommon, the UE 115-b may be signaled a RACH-CongGeneric and synchronization signal block (SSB) per RO as a common configuration across cell (e.g., mandatory). In some examples, the UE 115-b may receive a SI-RequestConfig, and the UE 115-b may receive an optional RACH-ConfigSI information element. If the RACH-ConfigSI information element is absent, the UE 115-b may derive the RACH resource (e.g., ROs) from the RACH-ConfigCommon for SI request.

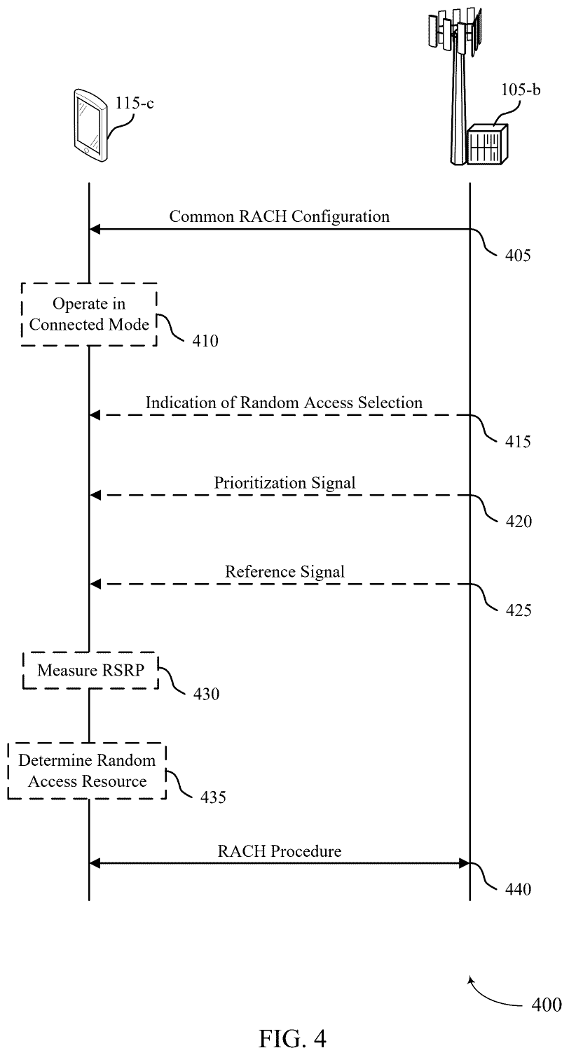

FIG. 4 shows an example of a process flow 400 that supports connected mode random access procedures with common random access configuration in accordance with one or more aspects of the present disclosure. The process flow 400 may implement or may be implemented by aspects of the wireless communications system 100, the network architecture 200, or the wireless communications system 300. For example, the process flow 400 may include a UE 115-c, which may be an example of a UE 115 as described herein. The process flow 400 may include a network entity 105-b, which may be an example of a network entity 105 as described herein. In the following description of the process flow 400, the operations between the network entity 105-b and the UE 115-c may be transmitted in a different order than the example order shown, or the operations performed by the network entity 105-b and the UE 115-c may be performed in different orders or at different times. Some operations may also be omitted from the process flow 400, and other operations may be added to the process flow 400.

At 405, the network entity 105-b may output, and the UE 115-c may receive, a common random access configuration, where the common random access configuration may be associated with one or more TDD uplink resources for random access and one or more SBFD uplink resources for random access.

At 410, the UE 115-c may operate in an RRC connected mode.

At 415, the network entity 105-b may output, and the UE 115-c may receive, an indication indicating random access resource selection.

At 420, the network entity 105-b may output, and the UE 115-c may receive, a prioritization signal, where the prioritization signal prioritizes the one or more TDD uplink resources over the one or more SBFD uplink resources or the one or more SBFD uplink resources over the one or more TDD uplink resources.

At 425, the network entity 105-b may output, and the UE 115-c may receive, a reference signal.

At 430, the UE 115-c may measure a RSRP associated with the reference signal.

At 435, the UE 115-c may determine a random access resource for a random access procedure based on occurrence of a trigger event. The random access procedure may be performed on a random access resource associated with the common random access configuration, and the random access resource may be determined from the one or more TDD uplink resources, from the one or more SBFD uplink resources, or from both the one or more TDD uplink resources and the one or more SBFD uplink resources based on the common random access configuration and based on an absence, at the UE 115-c, of a dedicated random access configuration that indicates the trigger event. In some examples, the determination of the random access resource by the UE 115-c may be based on the indication that indicates the random access resource is selected from the one or more TDD uplink resources. In some examples, the determination of the random access resource by the UE 115-c based at least in part on the indication that indicates the random access resource is selected from the one or more SBFD uplink resources.

In some cases, the determination of the random access resource by the UE 115-c may be based on the indication that indicates the random access resource is selected from both the one or more TDD uplink resources and the one or more SBFD uplink resources, and, in some cases, the UE 115-c may select the random access resource from only the one or more SBFD uplink resources.

In some examples, the UE 115-c may select the random access resource from only the one or more TDD uplink resources or from only the one or more SBFD uplink resources based at least in part on the prioritization signal.

In some examples, the UE 115-c may select the random access resource from the one or more SBFD uplink resources based at least in part on satisfaction of a threshold by the reference signal received power.

In some examples, the UE 115-c may select the random access resource from the one or more SBFD uplink resources based on satisfaction of a threshold by a transmit power associated with the random access procedure.

In some examples, the UE 115-c may receive a RRC parameter prior to determination of the random access resource. The determination of the random access resource by the UE 115-c may be based on the RRC that indicates the random access resource is selected from the one or more TDD uplink resources, the one or more SBFD uplink resources, or both the one or more TDD uplink resources and the one or more SBFD uplink resource.

In some cases, the UE 115-c may select the random access resource from only the one or more TDD uplink resources based on an absence of a RRC parameter that indicates that the random access resource is selected from the one or more TDD uplink resources, the one or more SBFD uplink resources, or both the one or more TDD uplink resources and the one or more SBFD uplink resources.

At 440, the UE 115-c may participate in the random access procedure based on occurrence of the trigger event.

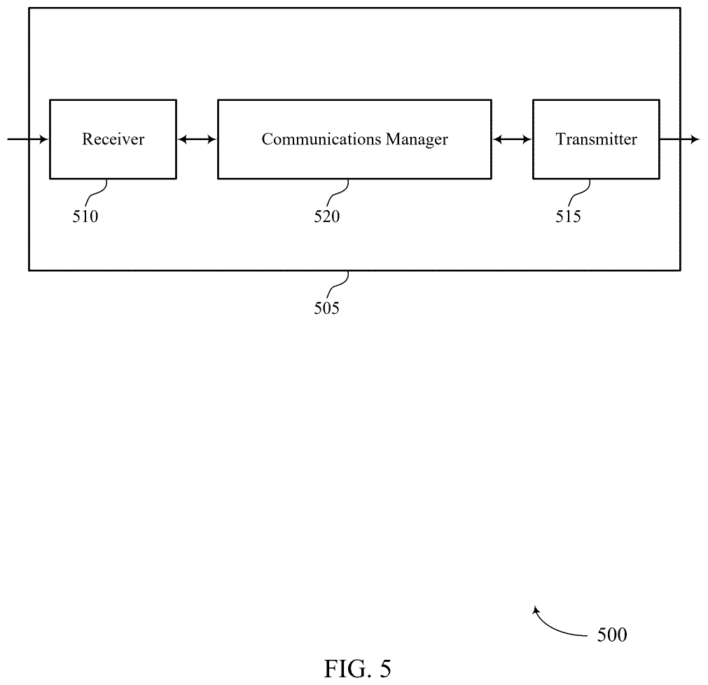

FIG. 5 shows a block diagram 500 of a device 505 that supports connected mode random access procedures with common random access configuration in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to connected mode random access procedures with common random access configuration). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to connected mode random access procedures with common random access configuration). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of connected mode random access procedures with common random access configuration as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for receiving a common random access configuration, where the common random access configuration is associated with one or more time domain duplex (TDD) uplink resources for random access and one or more subband full duplex (SBFD) uplink resources for random access. The communications manager 520 is capable of, configured to, or operable to support a means for participating in a random access procedure based on occurrence of a trigger event during an RRC connected mode of the UE, where the random access procedure is performed on a random access resource associated with the common random access configuration, the random access resource determined from the one or more TDD uplink resources, from the one or more SBFD uplink resources, or from both the one or more TDD uplink resources and the one or more SBFD uplink resources based on the common random access configuration and based on an absence, at the UE, of a dedicated random access configuration that indicates the trigger event.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

The communications manager 520 may be an example of means for performing various aspects of connected mode random access procedures with common random access configuration. The communications manager 520, or its sub-components, may be implemented in hardware (e.g., in communications management circuitry). The circuitry may comprise of processor, DSP, an ASIC, an FPGA or other programmable logic device, discrete gate or transistor logic, discrete hardware components, or any combination thereof designed to perform the functions described in the present disclosure.

In another implementation, the communications manager 520, or its sub-components, may be implemented in code (e.g., as communications management software or firmware) executed by a processor, or any combination thereof. If implemented in code executed by a processor, the functions of the communications manager 720, or its sub-components may be executed by a general-purpose processor, a DSP, an ASIC, an FPGA or other programmable logic device.

In some examples, the communications manager 520 may be configured to perform various operations (e.g., receiving, determining, transmitting) using or otherwise in cooperation with the receiver 510, the transmitter 515, or both.

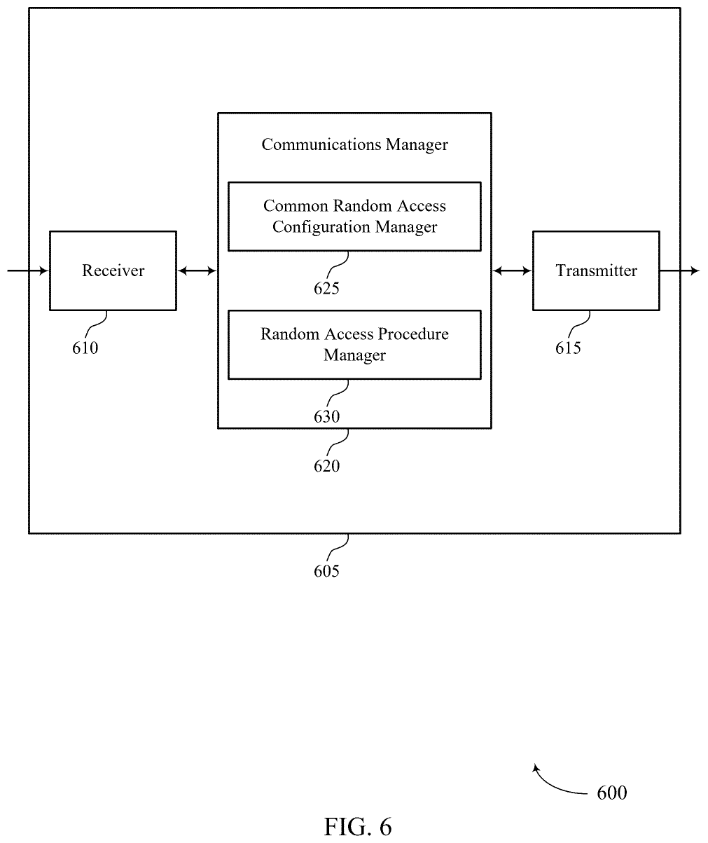

FIG. 6 shows a block diagram 600 of a device 605 that supports connected mode random access procedures with common random access configuration in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to connected mode random access procedures with common random access configuration). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to connected mode random access procedures with common random access configuration). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of connected mode random access procedures with common random access configuration as described herein. For example, the communications manager 620 may include a common random access configuration manager 625 a random access procedure manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The common random access configuration manager 625 is capable of, configured to, or operable to support a means for receiving a common random access configuration, where the common random access configuration is associated with one or more time domain duplex (TDD) uplink resources for random access and one or more subband full duplex (SBFD) uplink resources for random access. The random access procedure manager 630 is capable of, configured to, or operable to support a means for participating in a random access procedure based on occurrence of a trigger event during an RRC connected mode of the UE, where the random access procedure is performed on a random access resource associated with the common random access configuration, the random access resource determined from the one or more TDD uplink resources, from the one or more SBFD uplink resources, or from both the one or more TDD uplink resources and the one or more SBFD uplink resources based on the common random access configuration and based on an absence, at the UE, of a dedicated random access configuration that indicates the trigger event.

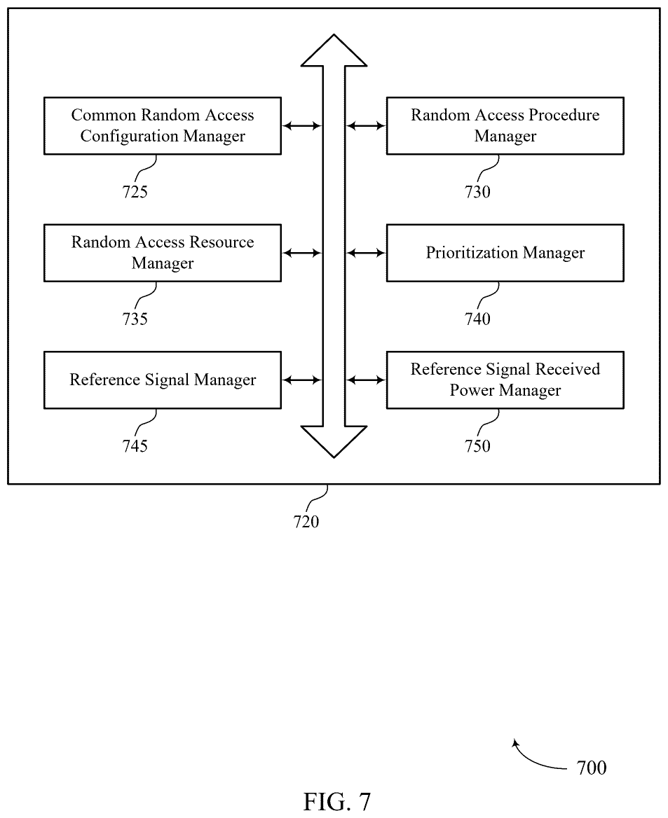

FIG. 7 shows a block diagram 700 of a communications manager 720 that supports connected mode random access procedures with common random access configuration in accordance with one or more aspects of the present disclosure. The communications manager 720 may be an example of aspects of a communications manager 520, a communications manager 620, or both, as described herein. The communications manager 720, or various components thereof, may be an example of means for performing various aspects of connected mode random access procedures with common random access configuration as described herein. For example, the communications manager 720 may include a common random access configuration manager 725, a random access procedure manager 730, a random access resource manager 735, a prioritization manager 740, a reference signal manager 745, a reference signal received power manager 750, or any combination thereof. Each of these components, or components or subcomponents thereof (e.g., one or more processors, one or more memories), may communicate, directly or indirectly, with one another (e.g., via one or more buses).

The communications manager 720 may support wireless communication in accordance with examples as disclosed herein. The common random access configuration manager 725 is capable of, configured to, or operable to support a means for receiving a common random access configuration, where the common random access configuration is associated with one or more time domain duplex (TDD) uplink resources for random access and one or more subband full duplex (SBFD) uplink resources for random access. The random access procedure manager 730 is capable of, configured to, or operable to support a means for participating in a random access procedure based on occurrence of a trigger event during an RRC connected mode of the UE, where the random access procedure is performed on a random access resource associated with the common random access configuration, the random access resource determined from the one or more TDD uplink resources, from the one or more SBFD uplink resources, or from both the one or more TDD uplink resources and the one or more SBFD uplink resources based on the common random access configuration and based on an absence, at the UE, of a dedicated random access configuration that indicates the trigger event.

In some examples, the random access resource manager 735 is capable of, configured to, or operable to support a means for receiving an indication prior to determination of the random access resource, the determination of the random access resource by the UE based on the indication that indicates the random access resource is selected from the one or more TDD uplink resources.

In some examples, the random access resource manager 735 is capable of, configured to, or operable to support a means for receiving an indication prior to determination of the random access resource, the determination of the random access resource by the UE based on the indication that indicates the random access resource is selected from the one or more SBFD uplink resources.

In some examples, the random access resource manager 735 is capable of, configured to, or operable to support a means for receiving an indication prior to determination of the random access resource, the determination of the random access resource by the UE based on the indication that indicates the random access resource is selected from both the one or more TDD uplink resources and the one or more SBFD uplink resources.

In some examples, the random access resource manager 735 is capable of, configured to, or operable to support a means for selecting the random access resource from only the one or more SBFD uplink resources.

In some examples, the prioritization manager 740 is capable of, configured to, or operable to support a means for receiving, from a network entity, a prioritization signal, where the prioritization signal prioritizes the one or more TDD uplink resources over the one or more SBFD uplink resources or the one or more SBFD uplink resources over the one or more TDD uplink resources. In some examples, the random access resource manager 735 is capable of, configured to, or operable to support a means for selecting the random access resource from only the one or more TDD uplink resources or from only the one or more SBFD uplink resources based on the prioritization signal.

In some examples, the reference signal manager 745 is capable of, configured to, or operable to support a means for receiving a reference signal. In some examples, the reference signal received power manager 750 is capable of, configured to, or operable to support a means for measuring a reference signal received power associated with the reference signal. In some examples, the random access resource manager 735 is capable of, configured to, or operable to support a means for selecting the random access resource from the one or more SBFD uplink resources based on satisfaction of a threshold by the reference signal received power.

In some examples, the random access resource manager 735 is capable of, configured to, or operable to support a means for selecting the random access resource from the one or more SBFD uplink resources based on satisfaction of a threshold by a transmit power associated with the random access procedure.

In some examples, the random access resource manager 735 is capable of, configured to, or operable to support a means for receiving a radio resource control parameter prior to determination of the random access resource, the determination of the random access resource by the UE based on the radio resource control parameter that indicates the random access resource is selected from the one or more TDD uplink resources, the one or more SBFD uplink resources, or both the one or more TDD uplink resources and the one or more SBFD uplink resources.

In some examples, the random access resource manager 735 is capable of, configured to, or operable to support a means for selecting the random access resource from only the one or more TDD uplink resources based on an absence of a radio resource control parameter that indicates that the random access resource is selected from the one or more TDD uplink resources, the one or more SBFD uplink resources, or both the one or more TDD uplink resources and the one or more SBFD uplink resources.

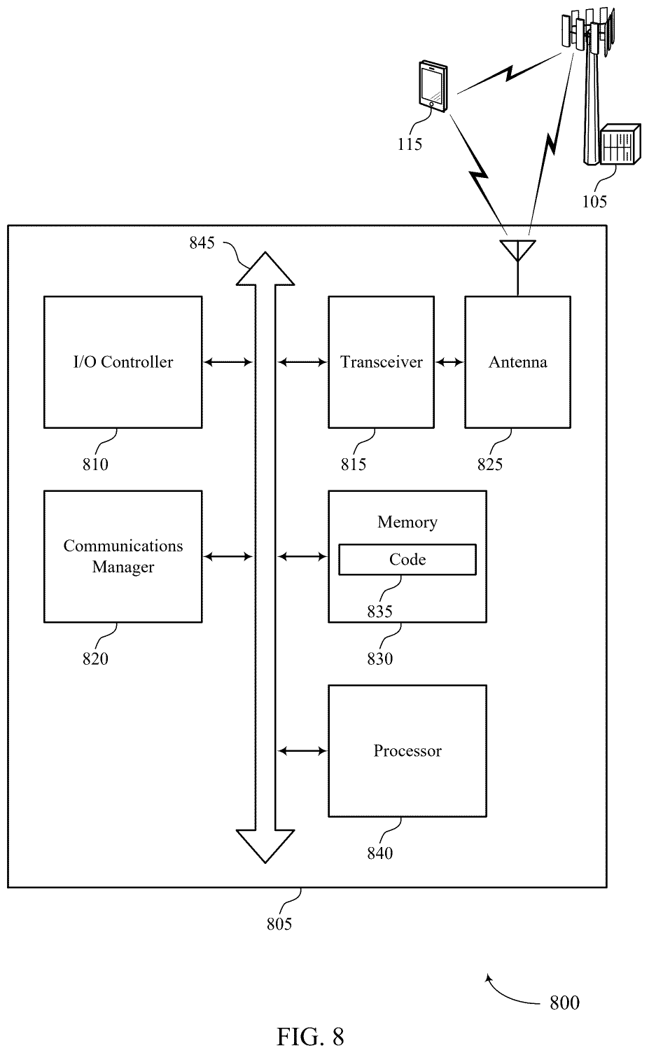

FIG. 8 shows a diagram of a system 800 including a device 805 that supports connected mode random access procedures with common random access configuration in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOSR, ANDROIDR, MS-DOSR, MS-WINDOWS®, OS/2R, UNIX®, LINUXR, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting connected mode random access procedures with common random access configuration). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communication in accordance with examples as disclosed herein. For example, the communications manager 820 is capable of, configured to, or operable to support a means for receiving a common random access configuration, where the common random access configuration is associated with one or more time domain duplex (TDD) uplink resources for random access and one or more subband full duplex (SBFD) uplink resources for random access. The communications manager 820 is capable of, configured to, or operable to support a means for participating in a random access procedure based on occurrence of a trigger event during an RRC connected mode of the UE, where the random access procedure is performed on a random access resource associated with the common random access configuration, the random access resource determined from the one or more TDD uplink resources, from the one or more SBFD uplink resources, or from both the one or more TDD uplink resources and the one or more SBFD uplink resources based on the common random access configuration and based on an absence, at the UE, of a dedicated random access configuration that indicates the trigger event.

By including or configuring the communications manager 820 in accordance with examples as described herein, the device 805 may support techniques for improved communication reliability, reduced latency, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of connected mode random access procedures with common random access configuration as described herein, or the at least one processor 840 and the at least one memory 830 may be otherwise configured to, individually or collectively, perform or support such operations.

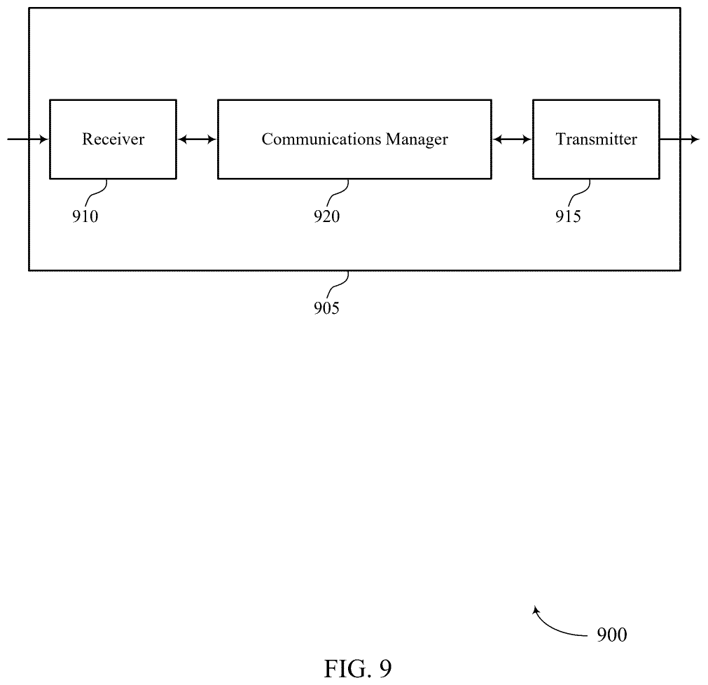

FIG. 9 shows a block diagram 900 of a device 905 that supports connected mode random access procedures with common random access configuration in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of connected mode random access procedures with common random access configuration as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 is capable of, configured to, or operable to support a means for outputting, to a UE, a common random access configuration, where the common random access configuration is associated with one or more time domain duplex (TDD) uplink resources for random access and one or more subband full duplex (SBFD) uplink resources for random access. The communications manager 920 is capable of, configured to, or operable to support a means for outputting, to the UE, an indication associated with selection of a random access resource for participation in a random access procedure, where the indication indicates the random access resource is to be selected from the one or more TDD uplink resources, the one or more SBFD uplink resources, or both the one or more TDD uplink resources and the one or more SBFD uplink resources based on the common random access configuration and based on an absence of a dedicated random access configuration that indicates a trigger event for the random access procedure.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources.

The communications manager 920 may be an example of means for performing various aspects of connected mode random access procedures with common random access configuration. The communications manager 920, or its sub-components, may be implemented in hardware (e.g., in communications management circuitry). The circuitry may comprise of processor, DSP, an ASIC, an FPGA or other programmable logic device, discrete gate or transistor logic, discrete hardware components, or any combination thereof designed to perform the functions described in the present disclosure.

In another implementation, the communications manager 920, or its sub-components, may be implemented in code (e.g., as communications management software or firmware) executed by a processor, or any combination thereof. If implemented in code executed by a processor, the functions of the communications manager 720, or its sub-components may be executed by a general-purpose processor, a DSP, an ASIC, an FPGA or other programmable logic device.

In some examples, the communications manager 920 may be configured to perform various operations (e.g., receiving, determining, transmitting) using or otherwise in cooperation with the receiver 910, the transmitter 915, or both.

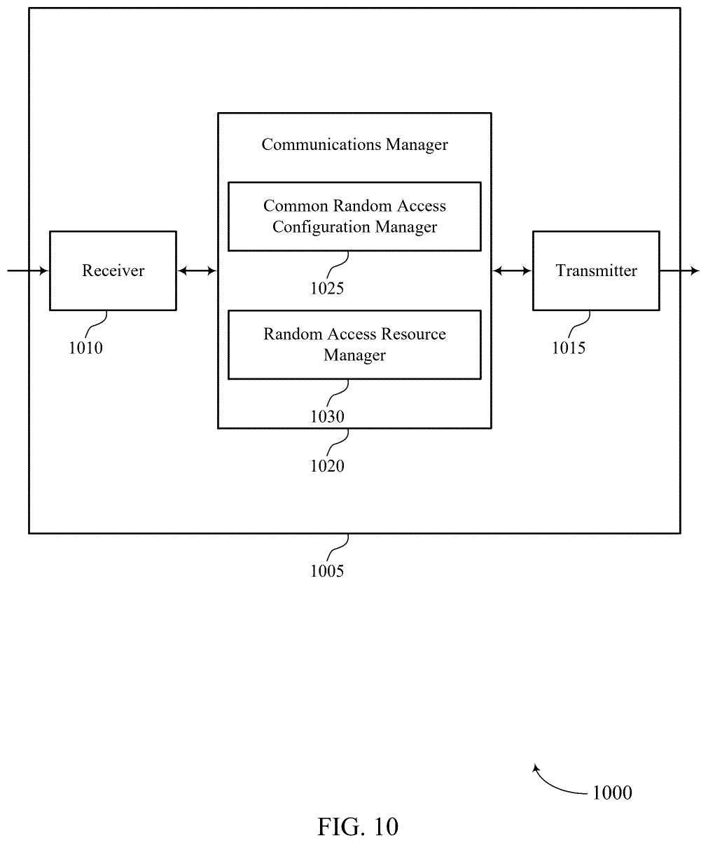

FIG. 10 shows a block diagram 1000 of a device 1005 that supports connected mode random access procedures with common random access configuration in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of connected mode random access procedures with common random access configuration as described herein. For example, the communications manager 1020 may include a common random access configuration manager 1025 a random access resource manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The common random access configuration manager 1025 is capable of, configured to, or operable to support a means for outputting, to a UE, a common random access configuration, where the common random access configuration is associated with one or more time domain duplex (TDD) uplink resources for random access and one or more subband full duplex (SBFD) uplink resources for random access. The random access resource manager 1030 is capable of, configured to, or operable to support a means for outputting, to the UE, an indication associated with selection of a random access resource for participation in a random access procedure, where the indication indicates the random access resource is to be selected from the one or more TDD uplink resources, the one or more SBFD uplink resources, or both the one or more TDD uplink resources and the one or more SBFD uplink resources based on the common random access configuration and based on an absence of a dedicated random access configuration that indicates a trigger event for the random access procedure.

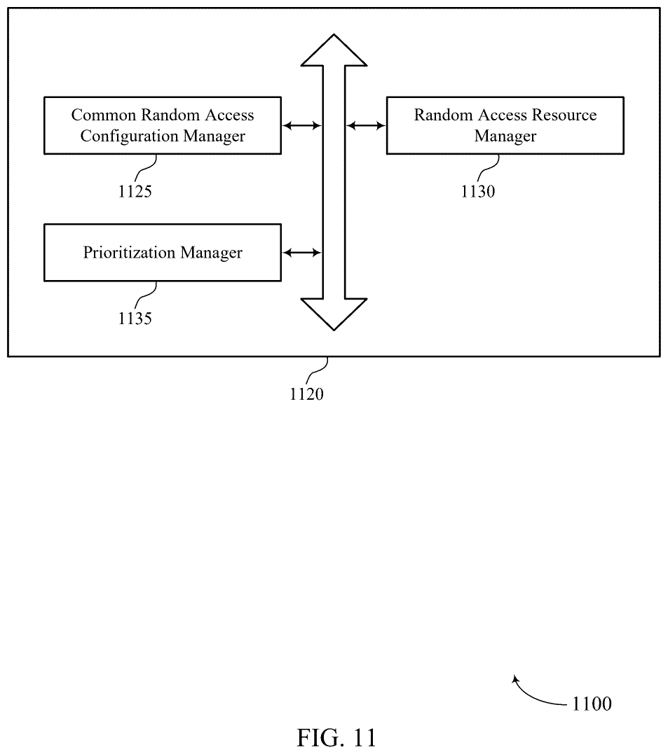

FIG. 11 shows a block diagram 1100 of a communications manager 1120 that supports connected mode random access procedures with common random access configuration in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of connected mode random access procedures with common random access configuration as described herein. For example, the communications manager 1120 may include a common random access configuration manager 1125, a random access resource manager 1130, a prioritization manager 1135, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication in accordance with examples as disclosed herein. The common random access configuration manager 1125 is capable of, configured to, or operable to support a means for outputting, to a UE, a common random access configuration, where the common random access configuration is associated with one or more time domain duplex (TDD) uplink resources for random access and one or more subband full duplex (SBFD) uplink resources for random access. The random access resource manager 1130 is capable of, configured to, or operable to support a means for outputting, to the UE, an indication associated with selection of a random access resource for participation in a random access procedure, where the indication indicates the random access resource is to be selected from the one or more TDD uplink resources, the one or more SBFD uplink resources, or both the one or more TDD uplink resources and the one or more SBFD uplink resources based on the common random access configuration and based on an absence of a dedicated random access configuration that indicates a trigger event for the random access procedure.

In some examples, the indication indicates the random access resource is to be selected from the one or more TDD uplink resources.

In some examples, the indication indicates the random access resource is to be selected from the one or more SBFD uplink resources.

In some examples, the indication indicates the random access resource is to be selected from both the one or more TDD uplink resources and the one or more SBFD uplink resources.

In some examples, the prioritization manager 1135 is capable of, configured to, or operable to support a means for outputting, to the UE, a prioritization signal, where the prioritization signal prioritizes the one or more TDD uplink resources over the one or more SBFD uplink resources or the one or more SBFD uplink resources over the one or more TDD uplink resources.

In some examples, the indication is a radio resource control parameter included in a radio resource control signal.

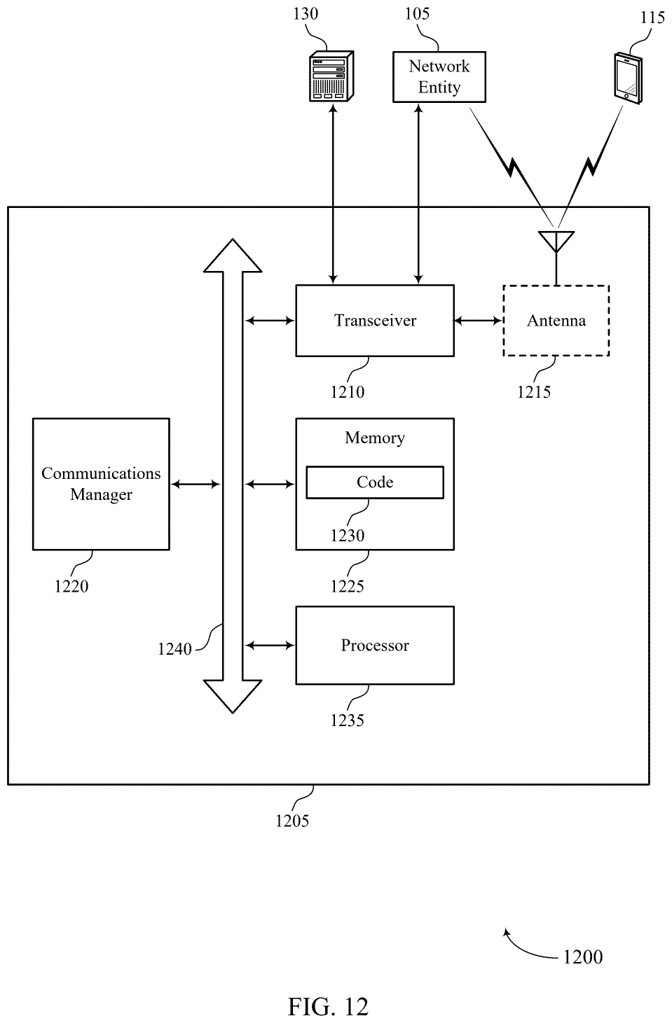

FIG. 12 shows a diagram of a system 1200 including a device 1205 that supports connected mode random access procedures with common random access configuration in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting connected mode random access procedures with common random access configuration). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communication in accordance with examples as disclosed herein. For example, the communications manager 1220 is capable of, configured to, or operable to support a means for outputting, to a UE, a common random access configuration, where the common random access configuration is associated with one or more time domain duplex (TDD) uplink resources for random access and one or more subband full duplex (SBFD) uplink resources for random access. The communications manager 1220 is capable of, configured to, or operable to support a means for outputting, to the UE, an indication associated with selection of a random access resource for participation in a random access procedure, where the indication indicates the random access resource is to be selected from the one or more TDD uplink resources, the one or more SBFD uplink resources, or both the one or more TDD uplink resources and the one or more SBFD uplink resources based on the common random access configuration and based on an absence of a dedicated random access configuration that indicates a trigger event for the random access procedure.

By including or configuring the communications manager 1220 in accordance with examples as described herein, the device 1205 may support techniques for improved communication reliability, reduced latency, more efficient utilization of communication resources, and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of connected mode random access procedures with common random access configuration as described herein, or the at least one processor 1235 and the at least one memory 1225 may be otherwise configured to, individually or collectively, perform or support such operations.

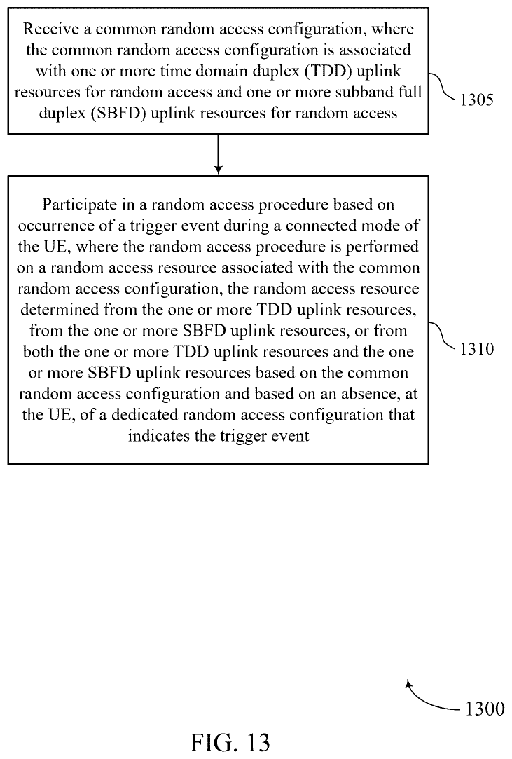

FIG. 13 shows a flowchart illustrating a method 1300 that supports connected mode random access procedures with common random access configuration in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a common random access configuration, where the common random access configuration is associated with one or more time domain duplex (TDD) uplink resources for random access and one or more subband full duplex (SBFD) uplink resources for random access. The operations of 1305 may be performed in accordance with examples as disclosed herein. In some examples, aspects of the operations of 1305 may be performed by a common random access configuration manager 725 as described with reference to FIG. 7.

At 1310, the method may include participating in a random access procedure based on occurrence of a trigger event during a connected mode of the UE, where the random access procedure is performed on a random access resource associated with the common random access configuration, the random access resource determined from the one or more TDD uplink resources, from the one or more SBFD uplink resources, or from both the one or more TDD uplink resources and the one or more SBFD uplink resources based on the common random access configuration and based on an absence, at the UE, of a dedicated random access configuration that indicates the trigger event. The operations of 1310 may be performed in accordance with examples as disclosed herein. In some examples, aspects of the operations of 1310 may be performed by a random access procedure manager 730 as described with reference to FIG. 7.

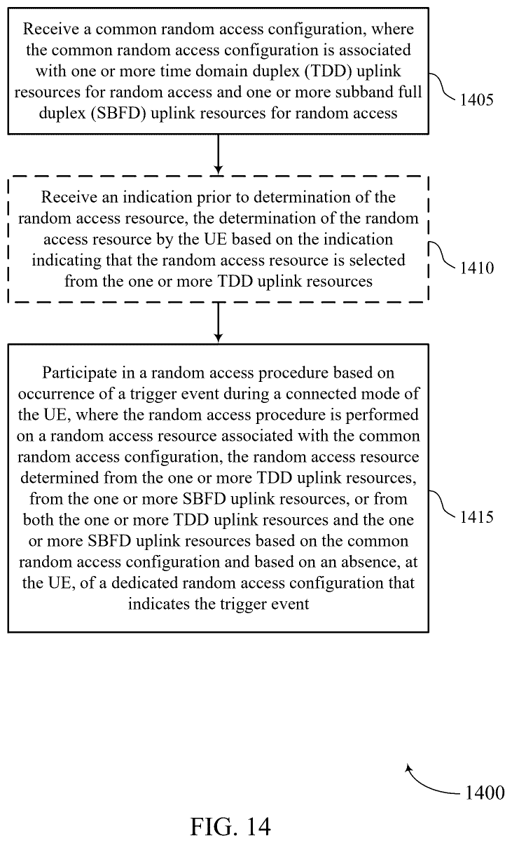

FIG. 14 shows a flowchart illustrating a method 1400 that supports connected mode random access procedures with common random access configuration in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a common random access configuration, where the common random access configuration is associated with one or more time domain duplex (TDD) uplink resources for random access and one or more subband full duplex (SBFD) uplink resources for random access. The operations of 1405 may be performed in accordance with examples as disclosed herein. In some examples, aspects of the operations of 1405 may be performed by a common random access configuration manager 725 as described with reference to FIG. 7.

At 1410, the method may include receiving an indication prior to determination of the random access resource, the determination of the random access resource by the UE based on the indication that indicates the random access resource is selected from the one or more TDD uplink resources. The operations of 1410 may be performed in accordance with examples as disclosed herein. In some examples, aspects of the operations of 1410 may be performed by a random access resource manager 735 as described with reference to FIG. 7.

At 1415, the method may include participating in a random access procedure based on occurrence of a trigger event during a connected mode of the UE, where the random access procedure is performed on a random access resource associated with the common random access configuration, the random access resource determined from the one or more TDD uplink resources, from the one or more SBFD uplink resources, or from both the one or more TDD uplink resources and the one or more SBFD uplink resources based on the common random access configuration and based on an absence, at the UE, of a dedicated random access configuration that indicates the trigger event. The operations of 1415 may be performed in accordance with examples as disclosed herein. In some examples, aspects of the operations of 1415 may be performed by a random access procedure manager 730 as described with reference to FIG. 7.

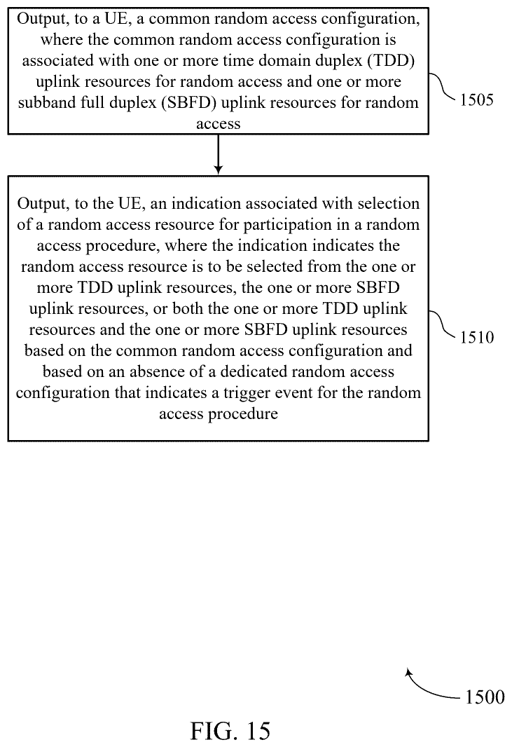

FIG. 15 shows a flowchart illustrating a method 1500 that supports connected mode random access procedures with common random access configuration in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include outputting, to a UE, a common random access configuration, where the common random access configuration is associated with one or more time domain duplex (TDD) uplink resources for random access and one or more subband full duplex (SBFD) uplink resources for random access. The operations of 1505 may be performed in accordance with examples as disclosed herein. In some examples, aspects of the operations of 1505 may be performed by a common random access configuration manager 1125 as described with reference to FIG. 11.

At 1510, the method may include outputting, to the UE, an indication associated with selection of a random access resource for participation in a random access procedure, where the indication indicates the random access resource is to be selected from the one or more TDD uplink resources, the one or more SBFD uplink resources, or both the one or more TDD uplink resources and the one or more SBFD uplink resources based on the common random access configuration and based on an absence of a dedicated random access configuration that indicates a trigger event for the random access procedure. The operations of 1510 may be performed in accordance with examples as disclosed herein. In some examples, aspects of the operations of 1510 may be performed by a random access resource manager 1130 as described with reference to FIG. 11.

The following provides an overview of aspects of the present disclosure:
Aspect 1: A method for wireless communication by a UE, comprising: receiving a common random access configuration, wherein the common random access configuration is associated with one or more TDD uplink resources for random access and one or more SBFD uplink resources for random access; and participating in a random access procedure based on occurrence of a trigger event during an RRC connected mode of the UE, wherein the random access procedure is performed on a random access resource associated with the common random access configuration, the random access resource determined from the one or more TDD uplink resources, from the one or more SBFD uplink resources, or from both the one or more TDD uplink resources and the one or more SBFD uplink resources based at least in part on the common random access configuration and based on an absence, at the UE, of a dedicated random access configuration that indicates the trigger event.
Aspect 2: The method of aspect 1, further comprising: receiving an indication prior to determination of the random access resource, the determination of the random access resource by the UE based at least in part on the indication that indicates the random access resource is selected from the one or more TDD uplink resources.
Aspect 3: The method of aspect 1, further comprising: receiving an indication prior to determination of the random access resource, the determination of the random access resource by the UE based at least in part on the indication that indicates the random access resource is selected from the one or more SBFD uplink resources.
Aspect 4: The method of aspect 1, further comprising: receiving an indication prior to determination of the random access resource, the determination of the random access resource by the UE based at least in part on the indication that indicates the random access resource is selected from both the one or more TDD uplink resources and the one or more SBFD uplink resources.
Aspect 5: The method of aspect 4, further comprising: selecting the random access resource from only the one or more SBFD uplink resources.
Aspect 6: The method of aspect 4, further comprising: receiving, from a network entity, a prioritization signal, wherein the prioritization signal prioritizes the one or more TDD uplink resources over the one or more SBFD uplink resources or the one or more SBFD uplink resources over the one or more TDD uplink resources; and selecting the random access resource from only the one or more TDD uplink resources or from only the one or more SBFD uplink resources based at least in part on the prioritization signal.
Aspect 7: The method of aspect 4, further comprising: receiving a reference signal: measuring a reference signal received power associated with the reference signal; and selecting the random access resource from the one or more SBFD uplink resources based at least in part on satisfaction of a threshold by the reference signal received power.
Aspect 8: The method of aspect 4, further comprising: selecting the random access resource from the one or more SBFD uplink resources based at least in part on satisfaction of a threshold by a transmit power associated with the random access procedure.
Aspect 9: The method of aspect 1, further comprising: receiving a radio resource control parameter prior to determination of the random access resource, the determination of the random access resource by the UE based at least in part on the radio resource control parameter that indicates the random access resource is selected from the one or more TDD uplink resources, the one or more SBFD uplink resources, or both the one or more TDD uplink resources and the one or more SBFD uplink resources.
Aspect 10: The method of aspect 1, further comprising: selecting the random access resource from only the one or more TDD uplink resources based at least in part on an absence of a radio resource control parameter that indicates that the random access resource is selected from the one or more TDD uplink resources, the one or more SBFD uplink resources, or both the one or more TDD uplink resources and the one or more SBFD uplink resources.
Aspect 11: A method for wireless communication by a network entity, comprising: outputting, to a UE, a common random access configuration, wherein the common random access configuration is associated with one or more TDD uplink resources for random access and one or more SBFD uplink resources for random access; and outputting, to the UE, an indication associated with selection of a random access resource for participation in a random access procedure, wherein the indication indicates the random access resource is to be selected from the one or more TDD uplink resources, the one or more SBFD uplink resources, or both the one or more TDD uplink resources and the one or more SBFD uplink resources based at least in part on the common random access configuration and based on an absence of a dedicated random access configuration that indicates a trigger event for the random access procedure.
Aspect 12: The method of aspect 11, wherein the indication indicates the random access resource is to be selected from the one or more TDD uplink resources.
Aspect 13: The method of aspect 11, wherein the indication indicates the random access resource is to be selected from the one or more SBFD uplink resources.
Aspect 14: The method of aspect 11, wherein the indication indicates the random access resource is to be selected from both the one or more TDD uplink resources and the one or more SBFD uplink resources.
Aspect 15: The method of aspect 14, further comprising: outputting, to the UE, a prioritization signal, wherein the prioritization signal prioritizes the one or more TDD uplink resources over the one or more SBFD uplink resources or the one or more SBFD uplink resources over the one or more TDD uplink resources.
Aspect 16: The method of aspect 11, wherein the indication is a radio resource control parameter included in a radio resource control signal.
Aspect 17: An apparatus for wireless communication at a UE, comprising one or more memories, and one or more processors coupled with the one or more memories and configured to cause the UE to: receive a common random access configuration, wherein the common random access configuration is associated with one or more TDD uplink resources for random access and one or more SBFD uplink resources for random access; and participate in a random access procedure based on occurrence of a trigger event during an RRC connected mode of the UE, wherein the random access procedure is performed on a random access resource associated with the common random access configuration, the random access resource determined from the one or more TDD uplink resources, from the one or more SBFD uplink resources, or from both the one or more TDD uplink resources and the one or more SBFD uplink resources based at least in part on the common random access configuration and based on an absence, at the UE, of a dedicated random access configuration that indicates the trigger event.
Aspect 18: The apparatus of aspect 19, wherein the one or more processors are further configured to cause the UE to: receive an indication prior to determination of the random access resource, the determination of the random access resource by the UE based at least in part on the indication that indicates the random access resource is selected from the one or more TDD uplink resources.
Aspect 20: The apparatus of aspect 21, wherein the one or more processors are further configured to cause the UE to: receive an indication prior to determination of the random access resource, the determination of the random access resource by the UE based at least in part on the indication that indicates the random access resource is selected from the one or more SBFD uplink resources.
Aspect 22: The apparatus of aspect 23, wherein the one or more processors are further configured to cause the UE to: receive an indication prior to determination of the random access resource, the determination of the random access resource by the UE based at least in part on the indication that indicates the random access resource is selected from both the one or more TDD uplink resources and the one or more SBFD uplink resources.
Aspect 24: The apparatus of aspect 25, wherein the one or more processors are further configured to cause the UE to: select the random access resource from only the one or more SBFD uplink resources.
Aspect 26: The apparatus of aspect 27, wherein the one or more processors are further configured to cause the UE to: receive, from a network entity, a prioritization signal, wherein the prioritization signal prioritizes the one or more TDD uplink resources over the one or more SBFD uplink resources or the one or more SBFD uplink resources over the one or more TDD uplink resources; and selecting the random access resource from only the one or more TDD uplink resources or from only the one or more SBFD uplink resources based at least in part on the prioritization signal.
Aspect 28: The apparatus of aspect 29, wherein the one or more processors are further configured to cause the UE to: receive a reference signal: measure a reference signal received power associated with the reference signal; and select the random access resource from the one or more SBFD uplink resources based at least in part on satisfaction of a threshold by the reference signal received power.
Aspect 30: The apparatus of aspect 31, wherein the one or more processors are further configured to cause the UE to: select the random access resource from the one or more SBFD uplink resources based at least in part on satisfaction of a threshold by a transmit power associated with the random access procedure.
Aspect 32: The apparatus of aspect 33, wherein the one or more processors are further configured to cause the UE to: receive a radio resource control parameter prior to determination of the random access resource, the determination of the random access resource by the UE based at least in part on the radio resource control parameter that indicates the random access resource is selected from the one or more TDD uplink resources, the one or more SBFD uplink resources, or both the one or more TDD uplink resources and the one or more SBFD uplink resources.
Aspect 34: The apparatus of aspect 35, wherein the one or more processors are further configured to cause the UE to: select the random access resource from only the one or more TDD uplink resources based at least in part on an absence of a radio resource control parameter that indicates that the random access resource is selected from the one or more TDD uplink resources, the one or more SBFD uplink resources, or both the one or more TDD uplink resources and the one or more SBFD uplink resources.
Aspect 36: An apparatus for wireless communication by a network entity, comprising one or more memories, and one or more processors coupled with the one or more memories and configured to cause the UE to: output, to a UE, a common random access configuration, wherein the common random access configuration is associated with one or more TDD uplink resources for random access and one or more SBFD uplink resources for random access; and output, to the UE, an indication associated with selection of a random access resource for participation in a random access procedure, wherein the indication indicates the random access resource is to be selected from the one or more TDD uplink resources, the one or more SBFD uplink resources, or both the one or more TDD uplink resources and the one or more SBFD uplink resources based at least in part on the common random access configuration and based on an absence of a dedicated random access configuration that indicates a trigger event for the random access procedure.
Aspect 37: The apparatus of aspect 38, wherein the indication indicates the random access resource is to be selected from the one or more TDD uplink resources.
Aspect 39: The apparatus of aspect 40, wherein the indication indicates the random access resource is to be selected from the one or more SBFD uplink resources.
Aspect 41: The apparatus of aspect 42, wherein the indication indicates the random access resource is to be selected from both the one or more TDD uplink resources and the one or more SBFD uplink resources.
Aspect 43: The apparatus of aspect 44, wherein the one or more processors are further configured to cause the network entity to: output, to the UE, a prioritization signal, wherein the prioritization signal prioritizes the one or more TDD uplink resources over the one or more SBFD uplink resources or the one or more SBFD uplink resources over the one or more TDD uplink resources.
Aspect 45: The apparatus of aspect 46, wherein the indication is a radio resource control parameter included in a radio resource control signal.
Aspect 47: A non-transitory computer-readable medium storing code for wireless communication, the code comprising instructions executable by one or more processors to perform a method of any of aspects 1 through 10.
Aspect 48: A non-transitory computer-readable medium storing code for wireless communication, the code comprising instructions executable by one or more processors to perform a method of any of aspects 11 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled with the one or more memories and configured to cause the UE to:
receive a common random access configuration, wherein the common random access configuration is associated with one or more time domain duplex (TDD) uplink resources for random access and one or more subband full duplex (SBFD) uplink resources for random access; and
participate in a random access procedure based on occurrence of a trigger event during a radio resource control (RRC) connected mode of the UE, wherein the random access procedure is performed on a random access resource associated with the common random access configuration, the random access resource determined from the one or more TDD uplink resources, from the one or more SBFD uplink resources, or from both the one or more TDD uplink resources and the one or more SBFD uplink resources based at least in part on the common random access configuration and based on an absence, at the UE, of a dedicated random access configuration that indicates the trigger event.

2. The apparatus of claim 1, wherein the one or more processors are further configured to cause the UE to:
receive an indication prior to determination of the random access resource, the determination of the random access resource by the UE based at least in part on the indication that indicates the random access resource is selected from the one or more TDD uplink resources.

3. The apparatus of claim 1, wherein the one or more processors are further configured to cause the UE to:
receive an indication prior to determination of the random access resource, the determination of the random access resource by the UE based at least in part on the indication that indicates the random access resource is selected from the one or more SBFD uplink resources.

4. The apparatus of claim 1, wherein the one or more processors are further configured to cause the UE to:
receive an indication prior to determination of the random access resource, the determination of the random access resource by the UE based at least in part on the indication that indicates the random access resource is selected from both the one or more TDD uplink resources and the one or more SBFD uplink resources.

5. The apparatus of claim 4, wherein the one or more processors are further configured to cause the UE to:
select the random access resource from only the one or more SBFD uplink resources.

6. The apparatus of claim 4, wherein the one or more processors are further configured to cause the UE to:
receive, from a network entity, a prioritization signal, wherein the prioritization signal prioritizes the one or more TDD uplink resources over the one or more SBFD uplink resources or the one or more SBFD uplink resources over the one or more TDD uplink resources; and
select the random access resource from only the one or more TDD uplink resources or from only the one or more SBFD uplink resources based at least in part on the prioritization signal.

7. The apparatus of claim 4, wherein the one or more processors are further configured to cause the UE to:
receive a reference signal;
measure a reference signal received power associated with the reference signal; and
select the random access resource from the one or more SBFD uplink resources based at least in part on satisfaction of a threshold by the reference signal received power.

8. The apparatus of claim 4, wherein the one or more processors are further configured to cause the UE to:
select the random access resource from the one or more SBFD uplink resources based at least in part on satisfaction of a threshold by a transmit power associated with the random access procedure.

9. The apparatus of claim 1, wherein the one or more processors are further configured to cause the UE to:
receive a radio resource control parameter prior to determination of the random access resource, the determination of the random access resource by the UE based at least in part on the radio resource control parameter that indicates the random access resource is selected from the one or more TDD uplink resources, the one or more SBFD uplink resources, or both the one or more TDD uplink resources and the one or more SBFD uplink resources.

10. The apparatus of claim 1, wherein the one or more processors are further configured to cause the UE to:
select the random access resource from only the one or more TDD uplink resources based at least in part on an absence of a radio resource control parameter that indicates that the random access resource is selected from the one or more TDD uplink resources, the one or more SBFD uplink resources, or both the one or more TDD uplink resources and the one or more SBFD uplink resources.

11. An apparatus for wireless communication at a network entity, comprising:
one or more memories; and
one or more processors coupled with the one or more memories and configured to cause the network entity to:
output, to a UE, a common random access configuration, wherein the common random access configuration is associated with one or more time domain duplex (TDD) uplink resources for random access and one or more subband full duplex (SBFD) uplink resources for random access; and
output, to the UE, an indication associated with selection of a random access resource for participation in a random access procedure, wherein the indication indicates the random access resource is to be selected from the one or more TDD uplink resources, the one or more SBFD uplink resources, or both the one or more TDD uplink resources and the one or more SBFD uplink resources based at least in part on the common random access configuration and based on an absence of a dedicated random access configuration that indicates a trigger event for the random access procedure.

12. The apparatus of claim 11, wherein the indication indicates the random access resource is to be selected from the one or more TDD uplink resources.

13. The apparatus of claim 11, wherein the indication indicates the random access resource is to be selected from the one or more SBFD uplink resources.

14. The apparatus of claim 11, wherein the indication indicates the random access resource is to be selected from both the one or more TDD uplink resources and the one or more SBFD uplink resources.

15. The apparatus of claim 14, wherein the one or more processors are further configured to cause the network entity to:
output, to the UE, a prioritization signal, wherein the prioritization signal prioritizes the one or more TDD uplink resources over the one or more SBFD uplink resources or the one or more SBFD uplink resources over the one or more TDD uplink resources.

16. The apparatus of claim 11, wherein the indication is a radio resource control parameter included in a radio resource control signal.

17. A method for wireless communication by a user equipment (UE), comprising:
receiving a common random access configuration, wherein the common random access configuration is associated with one or more time domain duplex (TDD) uplink resources for random access and one or more subband full duplex (SBFD) uplink resources for random access; and
participating in a random access procedure based on occurrence of a trigger event during a radio resource control (RRC) connected mode of the UE, wherein the random access procedure is performed on a random access resource associated with the common random access configuration, the random access resource determined from the one or more TDD uplink resources, from the one or more SBFD uplink resources, or from both the one or more TDD uplink resources and the one or more SBFD uplink resources based at least in part on the common random access configuration and based on an absence, at the UE, of a dedicated random access configuration that indicates the trigger event.

18. The method of claim 17, further comprising:
receiving an indication prior to determination of the random access resource, the determination of the random access resource by the UE based at least in part on the indication that indicates the random access resource is selected from the one or more TDD uplink resources.

19. The method of claim 17, further comprising:
receiving an indication prior to determination of the random access resource, the determination of the random access resource by the UE based at least in part on the indication that indicates the random access resource is selected from the one or more SBFD uplink resources.

20. The method of claim 17, further comprising:
receiving an indication prior to determination of the random access resource, the determination of the random access resource by the UE based at least in part on the indication that indicates the random access resource is selected from both the one or more TDD uplink resources and the one or more SBFD uplink resources.
